(19) United States
(12) Patent Application Publication
(10) Pub. No.: US 2018/0063559 A1
(43) Pub. Date: Mar. 1, 2018

(54) METHOD AND APPARATUS FOR CONTROLLING TRANSMISSION OF SWITCHED DIGITAL VIDEO SERVICE

(71) Applicant: ELECTRONICS AND TELECOMMUNICATIONS RESEARCH INSTITUTE, Daejeon (KR)

(72) Inventors: Tae-Kyoon KIM, Daejeon (KR); Yong-Seong CHO, Daejeon (KR); Joon-Young JUNG, Daejeon (KR); Nam-Ho HUR, Sejong (KR)

(21) Appl. No.: 15/660,741

(22) Filed: Jul. 26, 2017

(30) Foreign Application Priority Data
Aug. 25, 2016 (KR) 10-2016-0108188
Feb. 6, 2017 (KR) 10-2017-0016188

(51) Int. Cl. H04N 21/2385; H04N 21/472; H04N 21/6405; H04N 21/61

(52) U.S. Cl. CPC H04N 21/2385; H04N 21/6118; H04N 21/6405; H04N 21/472

(57) ABSTRACT

Disclosed herein is technology for controlling transmission of a switched digital video service through which an operator management and control system for efficiently managing and controlling a switched digital video transmission system, which may improve utilization of frequency resources, may be simply constructed and managed. To this end, a method for controlling transmission of a switched digital video service includes configuring a multicast session based on information about a request to transmit a video, which is transmitted from a user end; forming and controlling a service flow to be transmitted through the multicast session; allocating and managing a frequency channel resource through which the service flow is to be transmitted; and sharing information about the frequency channel resource and allocation thereof with a switched digital video control module and managing and controlling the switched digital video control module.

### CROSS REFERENCE TO RELATED APPLICATIONS

This application claims the benefit of Korean Patent Applications No. 10-2016-0108188, filed Aug. 25, 2016, and No. 10-2017-0016188, filed Feb. 6, 2017, which are hereby incorporated by reference in their entirety into this application.

### BACKGROUND OF THE INVENTION

### 1. Technical Field

The present invention relates generally to a method and apparatus for controlling transmission of switched digital video services, and more particularly, to a method and apparatus for controlling transmission of switched digital video services, in which an operator management and control system for efficiently managing and controlling a switched digital video transmission system, through which the utilization of frequency resources may be improved, may be simply constructed and managed.

### 2. Description of the Related Art

In conventional cable broadcast systems, digital video broadcast services are configured such that digital video data streams encoded in MPEG-2 are transmitted to users via Quadrature Amplitude Modulation (QAM) channels. Because the transmission method of the conventional cable broadcast systems has a structure in which all broadcast channels are transmitted regardless of whether viewers are currently viewing broadcast services, cable frequencies are wasted. Accordingly, it is necessary to use a transmission method for efficiently using the limited frequency resources of cable broadcast systems and to develop technology for controlling such a transmission method in order to satisfy requirements for services resulting from the emergence of new broadcast services.

In this regard, Korean Patent Application Publication No. 1999-0067136 discloses a video transmission system and method.

### SUMMARY OF THE INVENTION

An object of the present invention is to simply construct and manage an operator management and control system for efficiently managing and controlling a switched digital video transmission system through which broadcast data may be transmitted while efficiently using frequency bands.

In order to accomplish the above object, a method for controlling transmission of a switched digital video service according to an embodiment of the present invention includes configuring a multicast session based on information about a request to transmit a video, which is transmitted from a user end; forming and controlling a service flow to be transmitted through the multicast session; allocating and managing a frequency channel resource through which the service flow is to be transmitted; and sharing information about the frequency channel resource and allocation thereof with a switched digital video control module and managing and controlling the switched digital video control module.

Here, managing and controlling the switched digital video control module may be configured to perform at least one of execution of a command, management of a configuration file, collection of statistical information, monitoring, and collection of error information through communication with the switched digital video control module.

Here, when execution of the command is performed through communication with the switched digital video control module, managing and controlling the switched digital video control module may include controlling the switched digital control module so as to execute the command by receiving an item and a command selected through an operator GUI, by setting a parameter, and by transmitting the command to the switched digital control module; receiving a result of execution of the command from the switched digital video control module; and displaying the result of execution of the command and adding the result to a command history.

Here, when management of the configuration file is performed through communication with the switched digital video control module, managing and controlling the switched digital video control module may include receiving file information selected through an operator GUI and controlling the switched digital video control module so as to execute a command for loading a file corresponding to the file information; and receiving information about loading of the file from the switched digital video control module.

Here, when collection of the statistical information is performed through communication with the switched digital video control module, managing and controlling the switched digital video control module may include receiving a command for collecting statistical information, which includes a statistical command and a collection period set through an operator GUI, and transmitting the command to the switched digital video control module; and receiving a result of execution of the command from the switched digital video control module.

Here, when monitoring is performed through communication with the switched digital video control module, managing and controlling the switched digital video control module may include receiving a command for collecting channel-monitoring information, which includes a statistical command and a collection period set through an operator GUI, and transmitting the command to the switched digital video control module; and receiving a result of execution of the command from the switched digital video control module.

Here, the switched digital video control module may selectively deliver only a video stream that is currently being viewed by subscribers of a cable network service, among video streams flowing from a video program provider through a network, through a cable network.

Here, the switched digital video control module may transmit only a broadcast channel that is actually being viewed within a unit cell of a cable broadcast network.

Also, in order to accomplish the above object, an apparatus for controlling transmission of a switched digital video service according to an embodiment of the present invention may include a session configuration unit for configuring a multicast session based on information about a request to transmit a video, which is transmitted from a user end; a service flow control unit for forming and controlling a service flow to be transmitted through the multicast session; a channel resource management unit for allocating and managing a frequency channel resource through which the service flow is to be transmitted; and a Switched Digital Video (SDV) management unit for sharing information about the frequency channel resource and allocation thereof with a switched digital video control module and managing and controlling the switched digital video control module.

Here, the SDV management unit may perform at least one of execution of a command, management of a configuration file, collection of statistical information, monitoring, and collection of error information through communication with the switched digital video control module.

Here, when execution of the command is performed through communication with the switched digital video control module, the SDV management unit may be configured to control the switched digital video control module so as to execute the command by receiving an item and a command selected through an operator GUI, setting a parameter, and transmitting the command to the switched digital video control module; to receive a result of execution of the command from the switched digital video control module; and to display the result of execution of the command and add the result to a command history.

Here, when management of the configuration file is performed through communication with the switched digital video control module, the SDV management unit may be configured to receive file information selected through an operator GUI and control the switched digital video control module so as to execute a command for loading a file corresponding to the file information; and to receive information about loading of the file from the switched digital video control module.

Here, when collection of the statistical information is performed through communication with the switched digital video control module, the SDV management unit may be configured to receive a command for collecting statistical information, which includes a statistical command and a collection period set through an operator GUI, and transmit the command to the switched digital video control module; and to receive a result of execution of the command from the switched digital video control module.

Here, when monitoring is performed through communication with the switched digital video control module, the SDV management unit may be configured to receive a command for collecting channel-monitoring information, which includes a statistical command and a collection period set through an operator GUI, and transmit the command to the switched digital video control module; and to receive a result of execution of the command from the switched digital video control module.

Here, the switched digital video control module may selectively deliver only a video stream that is currently being viewed by subscribers of a cable network service, among video streams flowing from a video program provider through a network, through a cable network.

Here, the switched digital video control module may transmit only a broadcast channel that is actually being viewed within a unit cell of a cable broadcast network.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a flowchart for explaining a method for controlling transmission of a switched digital video service according to an embodiment of the present invention;

FIG. 2 is a flowchart for explaining a method for controlling and managing a switched digital video control module in a method for controlling transmission of a switched digital video service according to an embodiment of the present invention;

FIG. 3 shows an embodiment of a switched digital video service in a method for controlling transmission of a switched digital video service according to an embodiment of the present invention;

FIG. 4 is a block diagram that shows the configuration of an apparatus for controlling transmission of a switched digital video service according to an embodiment of the present invention;

FIG. 5 shows an example of an information message for control and management in technology for controlling transmission of a switched digital video service according to an embodiment of the present invention;

FIG. 6 shows an embodiment of a message for an apparatus management function;

FIG. 7 shows an embodiment of a message for a configuration file loading function;

FIGS. 8 to 10 show an embodiment of a message for a statistical information function;

FIGS. 11 to 13 show an embodiment of a message for a statistical channel information function; and

FIG. 14 shows an embodiment of a message used for reporting an event state to an operator.

### DESCRIPTION OF THE PREFERRED EMBODIMENTS

The present invention will be described in detail below with reference to the accompanying drawings. Repeated descriptions and descriptions of known functions and configurations which have been deemed to make the gist of the present invention unnecessarily obscure will be omitted below. The embodiments of the present invention are intended to fully describe the present invention to a person having ordinary knowledge in the art to which the present invention pertains. Accordingly, the shapes, sizes, etc. of components in the drawings may be exaggerated in order to make the description clearer.

Hereinafter, a method for controlling transmission of a switched digital video service according to an embodiment of the present invention will be described.

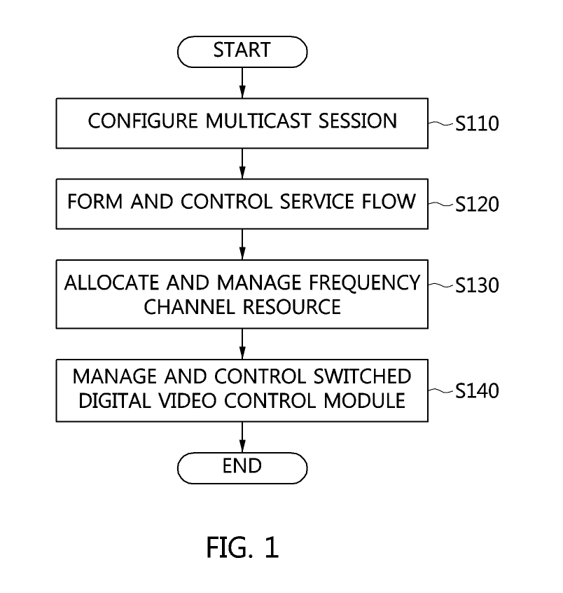

FIG. 1 is a flowchart for explaining a method for controlling transmission of a switched digital video service according to an embodiment of the present invention.

Referring to FIG. 1, in the method for controlling transmission of a switched digital video service according to an embodiment of the present invention, first, a multicast session is configured at step S110 based on information about a request to transmit a video, which is transmitted from a user end. Then, a service flow to be transmitted through the multicast session is formed and controlled at step S120. Also, a frequency channel resource for transmitting the service flow is allocated and managed at step S130.

Then, information about the frequency channel resource and allocation thereof is shared with a switched digital video control module, and the switched digital video control module is managed and controlled at step S140. Here, the switched digital video control module may select a video stream currently being viewed by the subscribers of a cable network service from among video streams flowing from a video program provider through a network, and may deliver only the selected video stream through a cable network. Also, the switched digital video control module may transmit only a broadcast channel that is actually being viewed within a unit cell of the cable network.

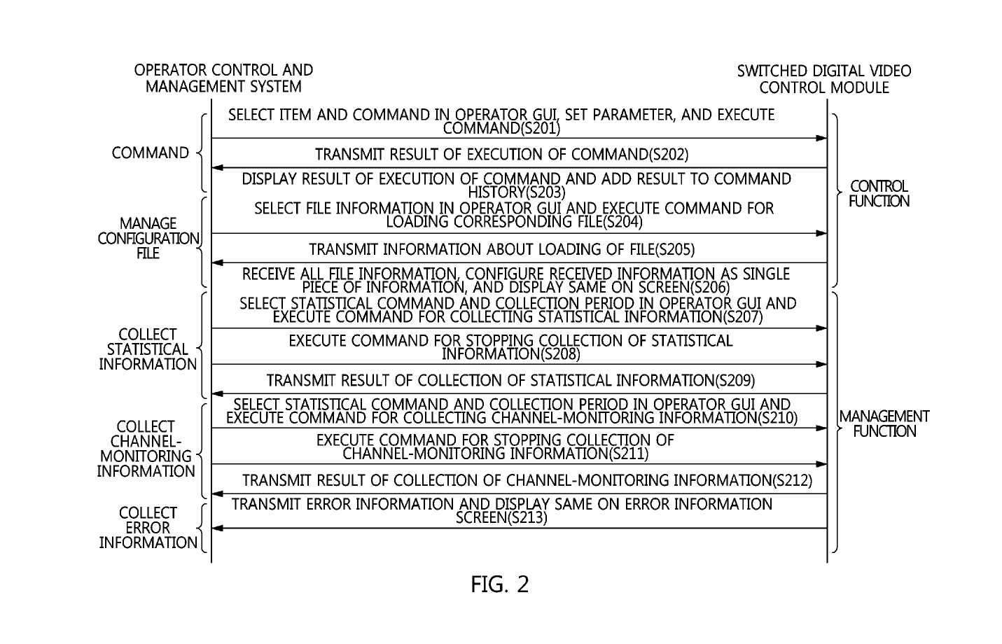

FIG. 2 is a flowchart for explaining a method for controlling and managing a switched digital video control module in the method for controlling transmission of a switched digital video service according to an embodiment of the present invention.

FIG. 2 shows a more detailed description of step S140 in FIG. 1. At step S140 in FIG. 1, at least one of execution of a command, management of a configuration file, collection of statistical information, collection of monitoring information (collection of channel-monitoring information), and collection of error information may be performed through communication with the switched digital video control module.

When a command is executed through communication with the switched digital video control module, step S201, in which the switched digital video control module is controlled so as to execute a command by selecting an item or a command through an operator GUI, setting a parameter, and transmitting it to the switched digital video control module, step S202, in which a result of execution of the command is received from the switched digital video control module, and step S203, in which the result of execution of the command is displayed and added to a command history, may be included.

Also, when the configuration file is managed through communication with the switched digital video control module, step S204, in which file information selected through the operator GUI is received and the switched digital video control module is controlled so as to execute a command for loading a file corresponding to the received file information, and step S205, in which information about loading of the file is received from the switched digital video control module, may be included. Also, step S206, in which, after all of the file loading information is received, all the received information is configured as a single piece of information and displayed on a screen, may be further included.

Also, when statistical information is collected through communication with the switched digital video control module, step S207, in which a command for collecting statistical information, which includes a statistical command and a collection period set through the operator GUI, is received and transmitted to the switched digital video control module, and step S209, in which a result of execution of the command for collecting statistical information is received from the switched digital video control module, may be included. Also, between step S207 and step S209, step S208, in which a command for stopping collection of statistical information is transmitted to the switched digital video control module, may be further included.

Also, when monitoring is performed through communication with the switched digital video control module, step S210, in which a command for collecting channel-monitoring information, which includes a statistical command and a collection period set through the operator GUI, is received and transmitted to the switched digital video control module, and step S212, in which a result of execution of the command for collecting channel-monitoring information is transmitted from the switched digital video control module, may be included. Also, between step S210 and step S212, step S211, in which a command for stopping collection of channel-monitoring information is transmitted to the switched digital video control module, may be further included.

Also, when error information is collected through communication with the switched digital video control module, step S213, in which error information is received from the switched digital video control module, may be included.

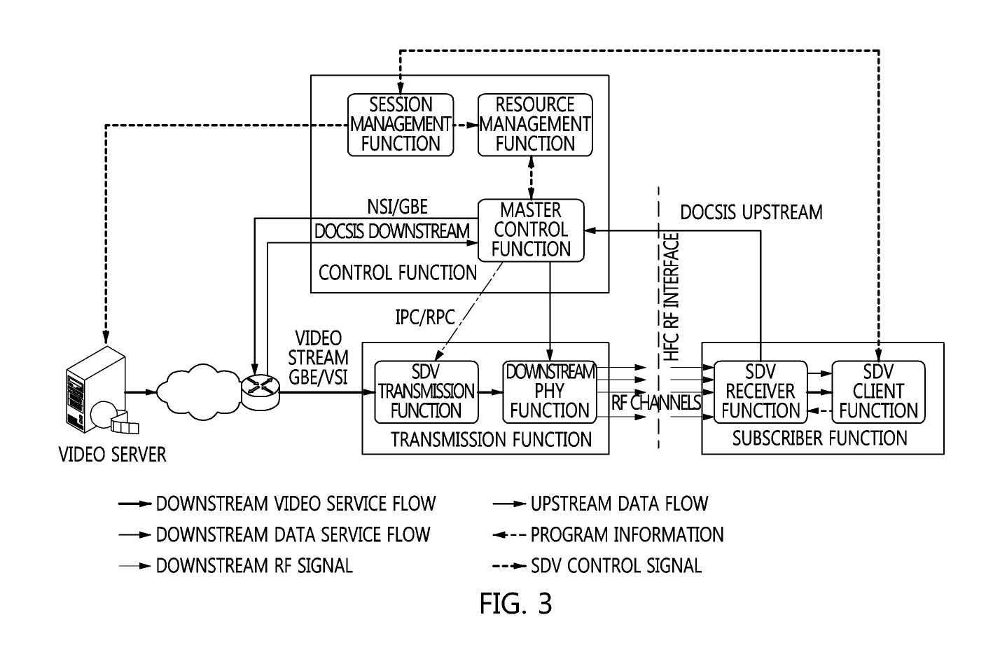

FIG. 3 shows an embodiment of a switched digital video service in the method for controlling transmission of a switched digital video service according to an embodiment of the present invention.

Referring to FIG. 3, an STB at a subscriber's side delivers information about a request for an IP-based channel change or a program session to a session management server of a cable provider's network based on some protocol. The session management server for a session management function may reserve an available frequency channel resource, which is sufficient to satisfy the transmission QoS required for transmission of a video program, through interworking with a resource management server, and may request a video server to configure an IP group session if there is no IP group session for transmitting a service from the video server to a subscriber. The resource management server is required to manage the frequency channel resource to be used to transmit a video program, enrolled by a master control unit, and the master control unit is required to set a frequency channel resource needed for video transmission and to control a connection. General data packets flowing from a network may be transmitted to a subscriber of a cable network via the master control unit. A switched digital video transmission device receives video data streams flowing from the network directly, not via the master control unit, and delivers them to subscribers through the cable network after processing a header for a DOCSIS service flow and scheduling. In order to enable video data streams flowing from the network to be processed by the switched digital video transmission device, the master control unit must be able to snoop on network protocol units, such as IGMP, ARP, and the like, which are delivered through an upstream channel, and the information acquired by snooping must be delivered using a control message from the master control unit to the switched digital video transmission device, rather than being directly delivered to the network. The switched digital video transmission device delivers the network protocol units, received from the master control unit, to the network in place of the master control unit, and may thereby induce routing devices in the network to set their paths such that data packets are to be transmitted to the switched digital video transmission device. Accordingly, the video data packets, flowing into the switched digital video transmission device, are scheduled and the headers thereof are processed depending on the set characteristics of a service flow defined in DOCSIS, and then the video data packets are transmitted according to the output of DOCSIS-EQAM, whereby the video data packets are delivered to subscribers through cable modems. The end point of the IP-based video streams, processed in the switched digital video transmission device, is an IP-STP, and a multicast or unicast-type video transmission service may be provided to each subscriber using the above-described method.

In an HFC-based cable network, a digital video broadcast service provided by a video program provider (PP) is broadcast to all subscribers through respective frequency channels based on MPEG-2 TS via the headend device of a cable broadcast service operator (SO), so that video programs of all the channels are delivered to subscribers within the same service group regardless of whether the subscribers are viewing a video channel or other channels. In this broadcast-type video transmission structure, because the headend device must use a cable network in order to deliver not only a video program that is currently being viewed by a subscriber service group but also all services that are likely to be viewed later, it is inefficient from the aspect of the use of frequency resources.

The switched digital video service transmission system selectively delivers only a video stream currently being viewed by cable network service subscribers, among video streams flowing from a video program provider via a network, via a cable network. That is, in contrast with existing systems, in which data of all broadcast channels are transmitted, a switched digital video service transmission system transmits only a broadcast channel being viewed by viewers, without transmitting broadcast channels that are not being viewed by viewers. Accordingly, an operator control and management system for effectively managing the switched digital video service transmission system is required. Here, the operator control and management module forms and controls a service group such that only the limited service group may receive video streams depending on requests from subscribers, and manages channel resources of the switched digital video transmission module through which a service flow is to be transmitted depending on the service group. Also, the operator control and management module configures a multicast session based on information about a request to transmit a video requested by subscribers, and configures or controls the service flow to be transmitted through the corresponding session. Also, a function of allocating and managing channel resources through which the service flow is to be transmitted and a device management function for the switched digital video transmission module may be performed by the operator control and management module.

The method for controlling transmission of a switched digital video service according to the present invention may be implemented as program instructions executable by various computer means and recorded in a computer-readable storage medium. The computer-readable storage medium may include program instructions, data files, and data structures, either solely or in combination. Program instructions recorded on the storage medium may have been specially designed and configured for the present invention, or may be known to or available to those who have ordinary knowledge in the field of computer software. Examples of the computer-readable storage medium include all types of hardware devices specially configured to record and execute program instructions, such as magnetic media, such as a hard disk, a floppy disk, and magnetic tape, optical media, such as CD-ROM and a DVD, magneto-optical media, such as a floptical disk, ROM, RAM, and flash memory. Examples of the program instructions include machine code, such as code created by a compiler, and high-level language code executable by a computer using an interpreter. The hardware devices may be configured to operate as one or more software modules in order to perform the operation of the present invention, and vice versa.

The instructions of the principles of the present invention may be implemented as a combination of hardware and software. Also, the software may be implemented as an application actually implemented on a program storage unit. The application may be uploaded to a machine including any appropriate architecture and be executed by the machine. Preferably, the machine may be implemented on a computer platform having hardware, such as one or more central processing units (CPUs), computer processors, RAM, and input/output (I/O) interfaces. Also, the computer platform may include an operating system and micro command code. The various processes and functions described herein may be a part of micro command code, a part of an application, or any combination thereof, and may be executed by various processing apparatuses including a CPU. Additionally, other various peripheral devices, such as an additional data storage unit and printer, may be connected to the computer platform.

Some of the constituent system components and the methods illustrated in the accompanying drawings are preferably implemented as software, so that it should be additionally appreciated that the actual connections between the system components or the process function blocks may vary according to the method for programming the principles of the present invention. When the aforementioned instructions are given, those skilled in the art may consider the implementation examples or configurations of the principles of the present invention.

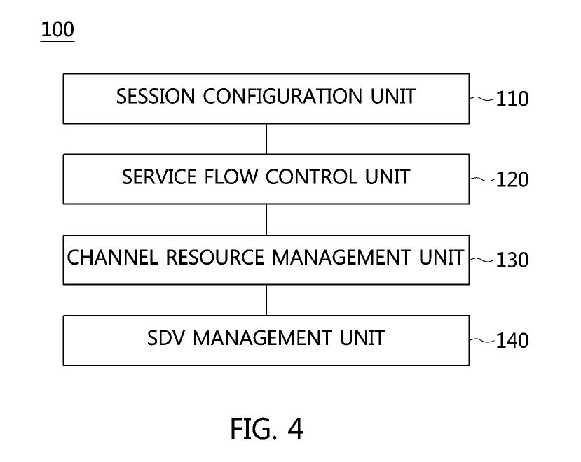

FIG. 4 is a block diagram that shows the configuration of an apparatus for controlling transmission of a switched digital video service according to an embodiment of the present invention.

Referring to FIG. 4, the apparatus 100 for controlling transmission of a switched digital video service according to an embodiment of the present invention may be configured to include a session configuration unit 110, a service flow control unit 120, a channel resource management unit 130, and a switched digital video (SDV) management unit 140.

The session configuration unit 110 configures a multicast session based on information about a request to transmit a video, which is received from a user end.

The service flow control unit 120 forms and controls a service flow to be transmitted through the multicast session.

The channel resource management unit 130 allocates and manages a frequency channel resource through which the service flow is to be transmitted.

The SDV management unit 140 shares information about the frequency channel resource and allocation thereof with a switched digital video control module and manages and controls the switched digital video control module. The SDV management unit 140 may perform at least one of execution of a command, management of a configuration file, collection of statistical information, monitoring, and collection of error information through communication with the switched digital video control module. Here, the switched digital video control module may perform control such that only a video stream currently being viewed by cable network service subscribers, among video streams flowing from a video program provider over a network, is selectively delivered through a cable network. Also, the switched digital video control module may transmit only a broadcast channel that is actually being viewed within a unit cell of a cable broadcast network.

Also, when a command is executed through communication with the switched digital video control module, the SDV management unit 140 may control the switched digital video control module so as to execute the command by selecting an item or a command through an operator GUI, setting a parameter, and transmitting it to the switched digital video control module, receive a result of execution of the command from the switched digital video control module, display the result of execution of the command, and add it to a command history.

Also, when a configuration file is managed through communication with the switched digital video control module, the SDV management unit 140 may receive file information selected through the operator GUI, control the switched digital video control module so as to execute a command for loading a file corresponding to the file information, and receive information about loading of the file from the switched digital video control module.

Also, when statistical information is collected through communication with the switched digital video control module, the SDV management unit 140 may receive a command for collecting statistical information, which includes a statistical command and a collection period set through the operator GUI, transmit the command for collecting statistical information to the switched digital video control module, and receive a result of execution of the command for collecting statistical information from the switched digital video control module.

Also, when monitoring is performed through communication with the switched digital video control module, the SDV management unit 140 may receive a command for collecting channel-monitoring information, which includes a statistical command and a collection period set through the operator GUI, transmit the command for collecting channel-monitoring information to the switched digital video control module, and receive a result of execution of the command for collecting channel-monitoring information from the switched digital video control module.

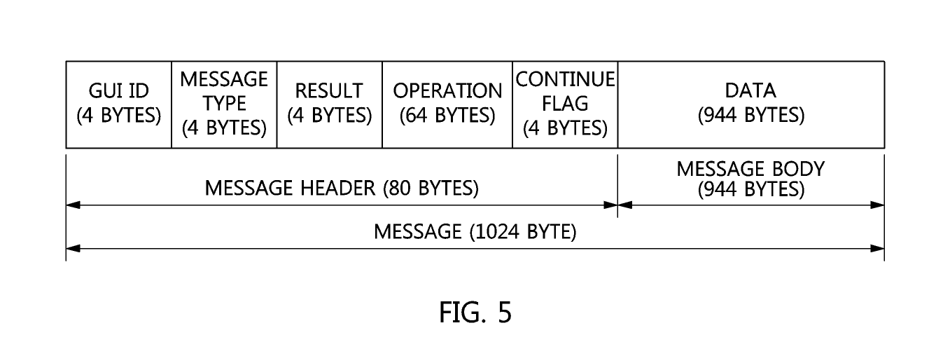

In technology for controlling transmission of a switched digital video service according to an embodiment of the present invention, a message for controlling and managing a switched digital video control module must be configured with a message header and a message body, wherein the message header may include information such as an ID, Message Type, Result, Operation, Continue Flag, and the like. FIG. 5 shows an example of an information message for control and management in the technology for controlling transmission of a switched digital video service according to an embodiment of the present invention.

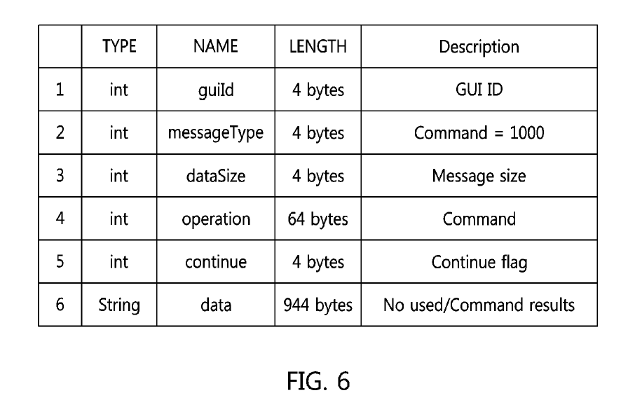

The message for control and management is required to perform the following functions. A device management function and a configuration file loading function must be performed through the message. Here, the formats of Req_dev_manage and Rsp_dev_manage messages, which are messages for a device management function, may be configured as shown in FIG. 6. FIG. 6 shows an embodiment of a message for a device management function.

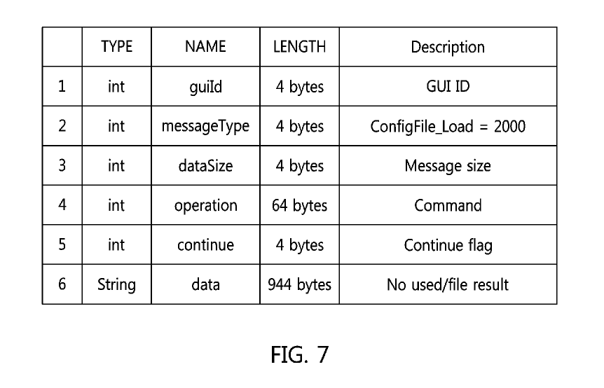

The formats of Req_cfg_fileload and Rsp_cfg_fileload messages, which are messages for a configuration file loading function, may be configured as shown in FIG. 7. FIG. 7 shows an embodiment of a message for a configuration file loading function.

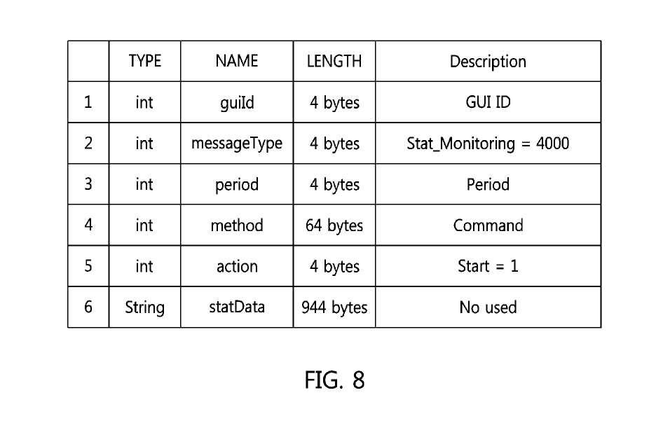

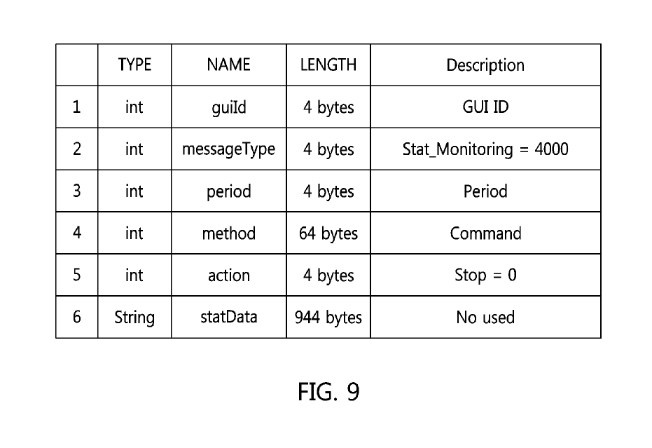

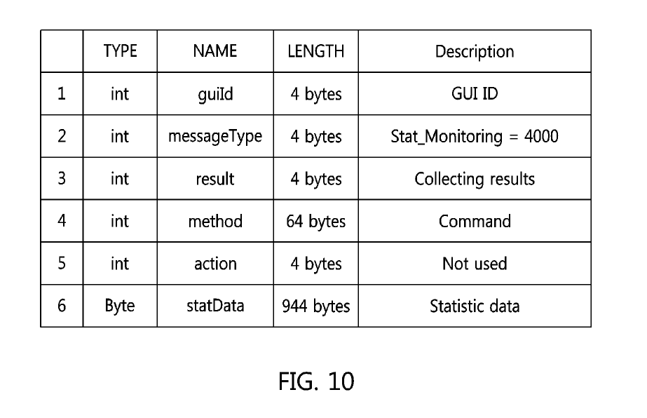

Also, the formats of Req_start_statistic_info, Rsp_start_statistic_info, Req_stop_statistic_info, Rsp_stop_statistic_info, and Rpt_statistic_info messages, which are messages for a statistical information function, may be configured as shown in FIGS. 8 to 10. FIGS. 8 to 10 show an embodiment of a message for a statistical information function.

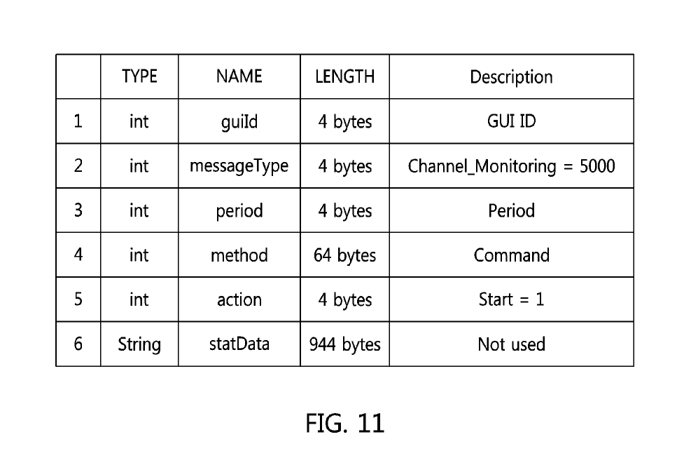

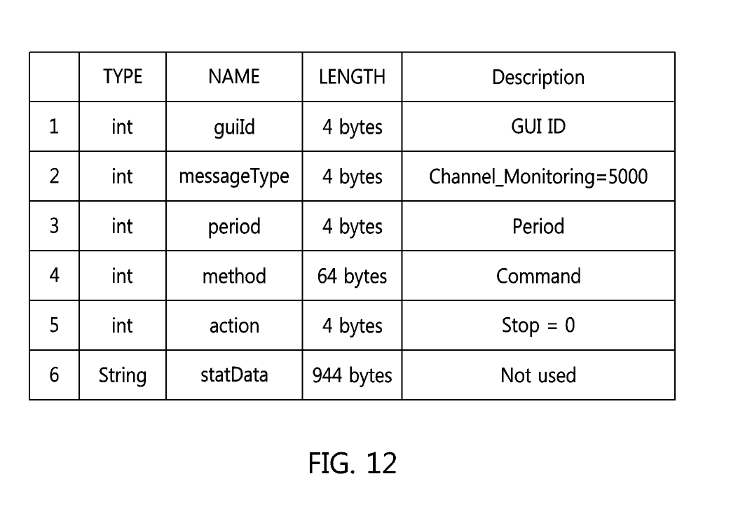

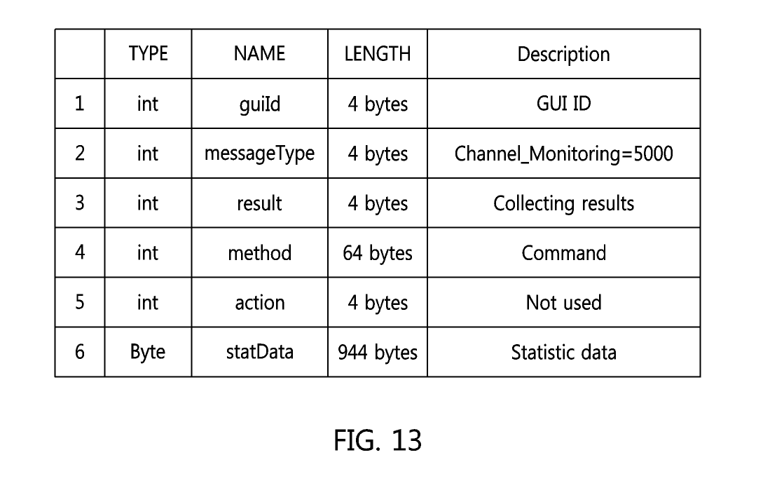

Also, the formats of Req_start_chstatistic_info, Rsp_start_chstatistic_info, Req_stop chstatistic_info, Rsp_stop chstatistic_info, and Rpt_chstatistic_info messages, which are messages for a statistical channel information function, may be configured as shown in FIGS. 11 to 13. FIGS. 11 to 13 show an embodiment of a message for a statistical channel information function.

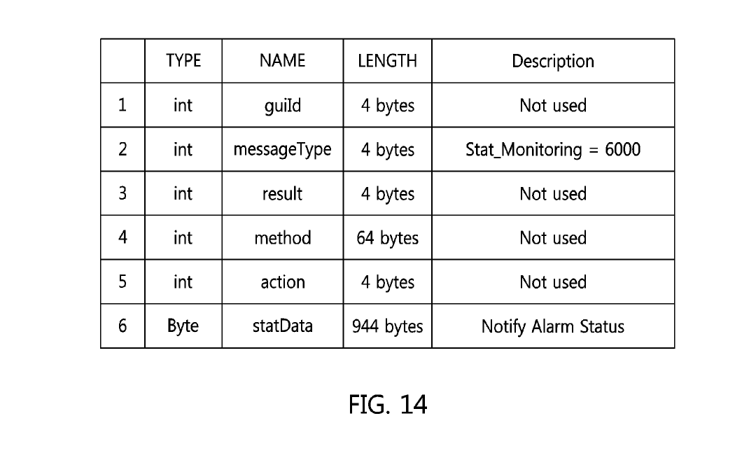

When an event, such as an error, occurs, the state thereof must be reported to an operator. The format of a message for an event report may be configured as shown in FIG. 14. FIG. 14 shows an embodiment of a message to be used to report the state of an event to an operator.

According to the present invention, it is possible to simply construct and manage an operator management and control system for efficiently managing and controlling a switched digital video transmission system through which broadcast data may be transmitted while efficiently using frequency bands.

As described above, the method and apparatus for controlling transmission of a switched digital video service according to the present invention are not limitedly applied to the configurations and operations of the above-described embodiments, but all or some of the embodiments may be selectively combined and configured, so that the embodiments may be modified in various ways.

What is claimed is:

1. A method for controlling transmission of a switched digital video service, comprising:
configuring a multicast session based on information about a request to transmit a video, which is transmitted from a user end;
forming and controlling a service flow to be transmitted through the multicast session;
allocating and managing a frequency channel resource through which the service flow is to be transmitted; and
sharing information about the frequency channel resource and allocation thereof with a switched digital video control module and managing and controlling the switched digital video control module.

2. The method of claim 1, wherein managing and controlling the switched digital video control module is configured to perform at least one of execution of a command, management of a configuration file, collection of statistical information, monitoring, and collection of error information through communication with the switched digital video control module.

3. The method of claim 2, wherein, when execution of the command is performed through communication with the switched digital video control module, managing and controlling the switched digital video control module comprises:
controlling the switched digital control module so as to execute the command by receiving an item and a command selected through an operator GUI, by setting a parameter, and by transmitting the command to the switched digital control module;
receiving a result of execution of the command from the switched digital video control module; and
displaying the result of execution of the command and adding the result to a command history.

4. The method of claim 2, wherein, when management of the configuration file is performed through communication with the switched digital video control module, managing and controlling the switched digital video control module comprises:
receiving file information selected through an operator GUI and controlling the switched digital video control module so as to execute a command for loading a file corresponding to the file information; and
receiving information about loading of the file from the switched digital video control module.

5. The method of claim 2, wherein, when collection of the statistical information is performed through communication with the switched digital video control module, managing and controlling the switched digital video control module comprises:
receiving a command for collecting statistical information, which includes a statistical command and a collection period set through an operator GUI, and transmitting the command to the switched digital video control module; and
receiving a result of execution of the command from the switched digital video control module.

6. The method of claim 2, wherein, when monitoring is performed through communication with the switched digital video control module, managing and controlling the switched digital video control module comprises:
receiving a command for collecting channel-monitoring information, which includes a statistical command and a collection period set through an operator GUI, and transmitting the command to the switched digital video control module; and
receiving a result of execution of the command from the switched digital video control module.

7. The method of claim 1, wherein the switched digital video control module selectively delivers only a video stream that is currently being viewed by subscribers of a cable network service, among video streams flowing from a video program provider through a network, through a cable network.

8. The method of claim 1, wherein the switched digital video control module transmits only a broadcast channel that is actually being viewed within a unit cell of a cable broadcast network.

9. An apparatus for controlling transmission of a switched digital video service, comprising:
a session configuration unit for configuring a multicast session based on information about a request to transmit a video, which is transmitted from a user end;
a service flow control unit for forming and controlling a service flow to be transmitted through the multicast session;
a channel resource management unit for allocating and managing a frequency channel resource through which the service flow is to be transmitted; and
a Switched Digital Video (SDV) management unit for sharing information about the frequency channel resource and allocation thereof with a switched digital video control module and managing and controlling the switched digital video control module.

10. The apparatus of claim 9, wherein the SDV management unit performs at least one of execution of a command, management of a configuration file, collection of statistical information, monitoring, and collection of error information through communication with the switched digital video control module.

11. The apparatus of claim 10, wherein, when execution of the command is performed through communication with the switched digital video control module, the SDV management unit is configured to:
control the switched digital video control module so as to execute the command by receiving an item and a command selected through an operator GUI, setting a parameter, and transmitting the command to the switched digital video control module;
receive a result of execution of the command from the switched digital video control module; and
display the result of execution of the command and add the result to a command history.

12. The apparatus of claim 10, wherein, when management of the configuration file is performed through communication with the switched digital video control module, the SDV management unit is configured to:
receive file information selected through an operator GUI and control the switched digital video control module so as to execute a command for loading a file corresponding to the file information; and
receive information about loading of the file from the switched digital video control module.

13. The apparatus of claim 10, wherein, when collection of the statistical information is performed through communication with the switched digital video control module, the SDV management unit is configured to:
receive a command for collecting statistical information, which includes a statistical command and a collection period set through an operator GUI, and transmit the command to the switched digital video control module; and
receive a result of execution of the command from the switched digital video control module.

14. The apparatus of claim 10, wherein, when monitoring is performed through communication with the switched digital video control module, the SDV management unit is configured to:
receive a command for collecting channel-monitoring information, which includes a statistical command and a collection period set through an operator GUI, and transmit the command to the switched digital video control module; and
receive a result of execution of the command from the switched digital video control module.

15. The apparatus of claim 9, wherein the switched digital video control module selectively delivers only a video stream that is currently being viewed by subscribers of a cable network service, among video streams flowing from a video program provider through a network, through a cable network.

16. The apparatus of claim 9, wherein the switched digital video control module transmits only a broadcast channel that is actually being viewed within a unit cell of a cable broadcast network.
